(19) United States
(12) Patent Application Publication
(10) Pub. No.: US 2009/0059063 A1
(43) Pub. Date: Mar. 5, 2009

(54) Camera mount bracket for mounting a thermal imaging camera to a protective helmet

(76) Inventor: Jeffrey Gallagher, Huber Heights, OH (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/899,345

(22) Filed: Sep. 5, 2007

(51) Int. Cl. H04N 5/225

(52) U.S. Cl. 348/373; 2/209.13; 348/E05.024

(57) ABSTRACT

A camera mount bracket (20) is provided for a thermal imaging camera (12) to be mounted to a protective helmet (14) having an identification shield (18) by removing the shield (18) from the helmet (14), placing the camera mount bracket (20) against the helmet (14) in the location normally occupied by the shield (18), and remounting the shield (18) to the helmet (14) with the camera bracket (20) sandwiched between the shield (18) and the helmet (14) using the fasteners (24) provided with the helmet (14) to mount the shield (18).

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to protective helmets of the type worn by firefighters or other emergency rescue workers and to thermal imaging cameras that can be mounted to such protective helmets.

### BACKGROUND OF THE INVENTION

As exemplified in U.S. Pat. No. 5,089,914, U.S. Pat. No. 6,016,160, U.S. Pat. No. 6,023,288, U.S. Pat. No. 6,476,391, and U.S. Pat. No. 6,606,391 B1, and in United States Patent Application Publication No. US 2003/0122958 A1, it is known to mount a thermal imaging camera and an associated display (viewer) to a firefighter's protective helmet, so as to provide the firefighter with thermal images of fallen or trapped persons or of heat-radiating objects, who or which would be otherwise obscured, as by smoke.

As exemplified in United States Patent Application Publication No. US 2003/0122958 A1, the disclosure of which is incorporated by reference herein, it is known to mount a thermal imaging camera above a front portion of a brim of a firefighter's helmet and to mount an associated display below the front brim. Therefore, advantageously, the thermal imaging camera provides the firefighter with a thermal image that is centered correctly, as compared to the thermal image provided to the firefighter by a thermal imaging camera placed to one side of the firefighter's head. While the disclosed structure has proven successful for its intended purpose, there is always room for improvement.

It is also known to equip a protective helmet of the type noted above with an identification shield or badge having a front face bearing indicia by mounting the identification shield is mounted to the front of the helmet using one or more mount points, that are typically configured to allow removal and replacement of the identification badge.

### SUMMARY OF THE INVENTION

In accordance with one feature of the invention, a bracket is provided for mounting a camera to a protective helmet having an identification shield mounted to a mount point of the helmet by a fastener. The bracket includes a helmet mount portion having an upper edge, a lower edge, and a mount opening between the upper and lower edges and located to align with the mount point of the helmet; and a camera mount portion extending from the helmet mount portion to provide a mount location for the camera.

As one feature, the helmet mount portion has a thickness that is sized to allow the identification shield to be mounted over the helmet mount portion with the fastener mounting the shield and bracket to the helmet.

In one feature, the camera mount portion extends from the lower edge and beneath the identification shield with the bracket and shield mounted to the helmet. As a further feature, the camera mount portion further includes a mount pad for receiving a mating mount pad of the camera.

According to one feature, the helmet mount portion further includes another mount opening located to align with another mount point on the helmet.

In accordance with one feature of the invention, a protective head gear combination is provide for mounting a camera for use by a firefighter or other emergency worker wearing the protective head gear combination. The combination including a protective helmet having a mount point, an identification shield mounted to the mount point, and a camera mount bracket mounted to the mount point, sandwiched between the identification shield and the protective helmet.

As one feature, the combination further includes a fastener extending through the shield and the camera mount bracket to engage the mount point.

In one feature, the fastener is a threaded fastener, and the mount point includes a threaded opening receiving the threaded fasteners.

According to one feature, the helmet further includes another mount point and the bracket and shield are mounted to the mount point. As a further feature, the combination further includes a pair of fasteners extending through the shield and the bracket to engage the mount points. In yet a further feature, each of the fasteners is a threaded fastener and each of the mount points includes a threaded opening receiving one of the threaded fasteners.

In accordance with one feature of the invention, a method if provided for connecting a camera mount bracket to a protective helmet having an identification shield mounted to the helmet. The method includes the steps of removing the identification shield from the protective helmet, placing the camera mount bracket against the helmet in a location normally occupied by the identification shield, and remounting the identification shield to the helmet with the camera mount bracket sandwiched between the identification shield and the helmet.

As one feature, the step of removing the identification shield includes the step of removing at least one fastener connecting the shield to the helmet, and the step of remounting the identification shield includes the step of reconnecting the at least one fastener to the helmet.

In one feature, the step of removing the identification shield includes the step of removing at least one threaded fastener connecting the shield to the helmet, and the step of remounting the identification shield includes the step of reconnecting the at least one threaded fastener to the helmet. As a further feature, the step of reconnecting the at least one treaded fastener to the helmet includes the step of inserting the at least one fastener through aligned openings in the identification shield and the camera mount bracket.

According to one feature, the step of removing at least one fastener includes removing two fasteners, and the step of reconnecting the at least one fastener includes reconnecting the two fasteners to the helmet.

As one feature, the step of reconnecting the at least one fastener includes the step of inserting the at least one fastener through aligned openings in the identification shield and the camera mount bracket.

Other objects, features, and advantages of the invention will become apparent from a review of the entire specification, including the appended claims and drawings.

### BRIEF DESCRIPTION OF THE DRAWINGS

FIG. 1 is a perspective view of a protective head gear combination embodying the invention and including a protective helmet, an identification shield, and a camera mount bracket for mounting a thermal imaging camera;

FIG. 2 is an exploded perspective view of the protective head gear combination of FIG. 1, with the identification shield shown in phantom;

FIG. 3 is a perspective view of the camera mount bracket of FIGS. 1 and 2 embodying the present invention; and

FIG. 4 is a side view of the camera mount bracket of FIGS. 1-3 showing the thermal imaging camera for mounting to the bracket.

### DETAILED DESCRIPTION OF THE PREFERRED EMBODIMENT

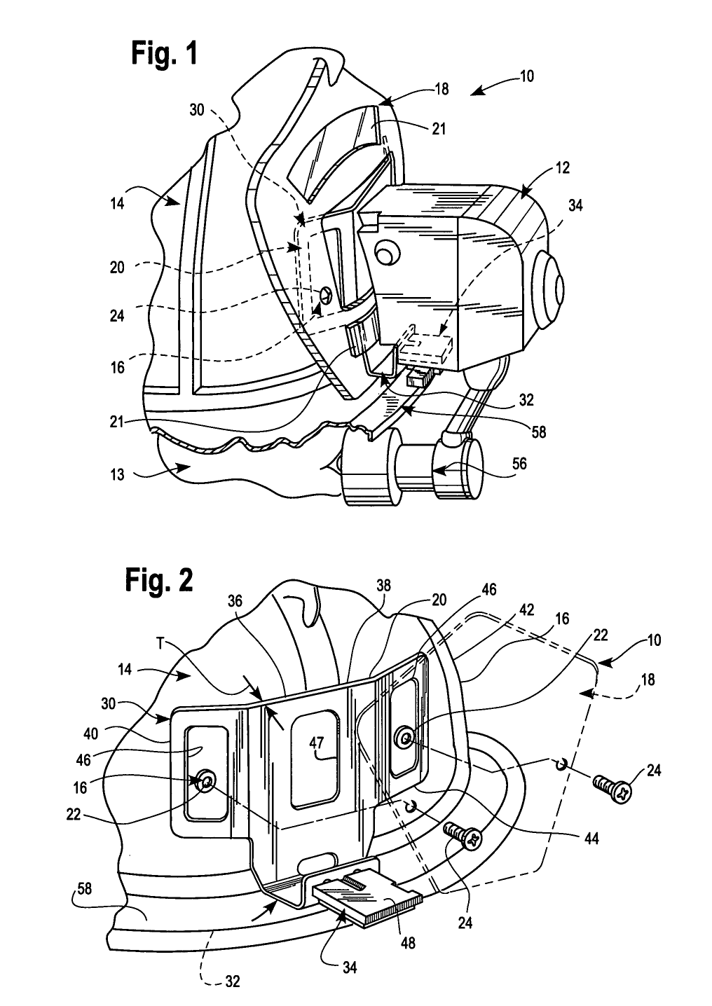

As best seen in FIGS. 1 and 2, a protective head gear combination 10 is provided for mounting a camera, such as a thermal imaging camera 12, for use by a firefighter or other type of emergency worker 13 wearing the protective head gear combination 10. The combination 10 includes a protective helmet 14 having mount points 16, an identification shield 18 mounted to the mount points 16, and a camera mount bracket 20 mounted to the mount point 16, sandwiched between the identification shield 18 and the protective helmet 14. The identification shield 18 includes indicia 21 on its front face, as is typical. Preferably, the helmet 14 and indication identification shield 18 are of any conventional, standard configuration that is used by a firefighter or other type of emergency worker.

In the illustrated embodiment, each of the mount points 16 is provided in the form of a threaded opening 22 that receives a threaded fastener 24 that is inserted through the identification shield 18 into engagement with the threaded openings 22 to connect the shield 18 to the helmet 14, which is typical of at least one standard construction of protective helmet worn by firefighters. In this regard, it should be appreciated that other styles of helmets, mounting points, and fasteners, as well as different numbers of mount points can be utilized with the invention.

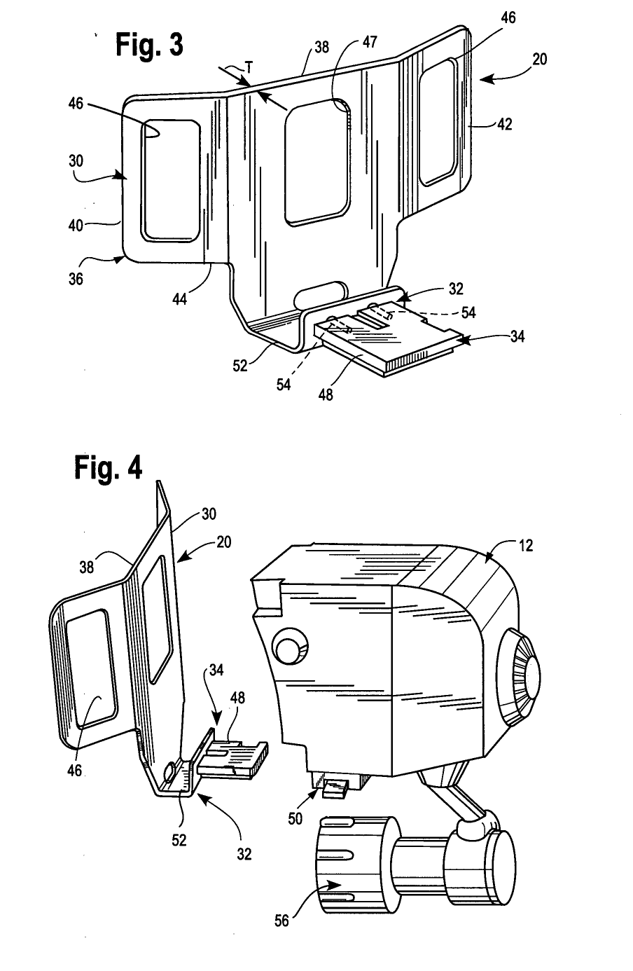

As best seen in FIGS. 3 and 4, the camera mount bracket 20 includes a helmet mount portion 30 and a camera mount portion 32 extending from the helmet mount portion 30 to provide a mount location 34 for the camera 12. The helmet mount portion 30 has a periphery 36 defining an upper edge 38, a pair of side edges 40 and 42 and a lower edge 44. The helmet mount portion 30 also includes a pair of mount openings 46 that are located to align with the mount points 16 of the helmet 14. As seen in the illustrated embodiment, the mount portion 30 can be provided with one or more additional mount openings 47 in order to allow use with other mount point configurations. The helmet mount portion 30 has a thickness T that is sized to allow the identification shield 18 to be mounted over the helmet mount portion 30 with the fasteners 24 mounting the identification shield 18 and camera mount bracket 20 to the helmet 14 so that the helmet mount portion 30 is sandwiched between the shield 18 and the protective helmet 14, as best seen in FIG. 1.

The camera mount portion 32 preferably extends from the lower edge 44 and beneath the identification shield 18 and includes a mount pad 48 for receiving a mating mount pad 50 of the camera 12. In the illustrated embodiment, the mount pad 48 is a separate piece that is attached to an L-shaped tongue 52 by a pair of suitable threaded fasteners 54 that extend through the L-shaped tongue 52 into engagement with the mount pad 48. Preferably, the mount pads 48 and 50 can be of any suitable quick disconnect type, many of which are known, to allow the camera 12 to be easily connected to and removed from the bracket 20.

Preferably, as seen in FIG. 1, the combination 10 allows for the camera 12 to be mounted so that an eye piece or display 56 of the camera 12 extends below a brim 58 of the helmet 14 to be positioned in front of an eye 60 of the firefighter or emergency worker 13.

With the exception of the mounting pad 48, it is preferred that the helmet mount portion 30 and camera mount portion 32 be a unitary construction made from a single piece of material, such as a single piece of suitable sheet metal, high temperature plastic, or composite material.

It should be appreciated that the bracket 20 allows for the thermal imaging camera 12 to be mounted to conventional, standard protective helmets having an identification shield, such as the shield 18, by simply removing the shield 18 from the helmet 14, placing the camera mount bracket 20 against the helmet 14 in the location normally occupied by the shield 18, and remounting the shield 18 to the helmet 14 with the camera bracket 20 sandwiched between the shield 18 and the helmet 14 using the fasteners 24 provided with the helmet 14. Accordingly, the bracket 20 allows for a camera 12 to be used with available protective helmets without requiring any modification to the helmets for mounting the camera 12.

1. A bracket for mounting a camera to a protective helmet having an identification shield mounted to a mount point of the helmet by a fastener, the bracket comprising:
a helmet mount portion having an upper edge, a lower edge, and a mount opening between the upper and lower edges and located to align with the mount point of the helmet; and
a camera mount portion extending from the helmet mount portion to provide a mount location for the camera.

2. The bracket of claim 1 wherein the helmet mount portion has a thickness that is sized to allow the identification shield to be mounted over the helmet mount portion with the fastener mounting the shield and bracket to the helmet.

3. The bracket of claim 2 wherein the camera mount portion extends from the lower edge and beneath the identification shield with the bracket and shield mounted to the helmet.

4. The bracket of claim 1 wherein the camera mount portion further comprises a mount pad for receiving a mating mount pad of the camera.

5. The bracket of claim 1 wherein the helmet mount portion further comprises another mount opening located to align with another mount point on the helmet.

6. A protective head gear combination for mounting a camera, the combination comprising:
a protective helmet having a mount point;
an identification shield mounted to the mount point; and
a camera mount bracket mounted to the mount point, sandwiched between the identification shield and the protective helmet.

7. The combination of claim 6 wherein the camera mount bracket comprises:
a helmet mount portion sandwiched between the shield and the helmet and having an upper edge, a lower edge, and a mount opening between the upper and lower edges and located to align with the mount point of the helmet; and
a camera mount portion extending from the helmet mount portion to provide a mount location for the camera.

8. The combination of claim 7 wherein the camera mount portion extends from the lower edge and beneath the identification shield.

9. The combination of claim 7 wherein the camera mount portion further comprises a mount pad for receiving a mating mount pad of the camera.

10. The combination of claim 6 further comprising a fastener extending through the shield and the camera mount bracket to engage the mount point.

11. The combination of claim 10 wherein:
the fastener is a threaded fastener; and
the mount point comprises a threaded opening receiving the threaded fasteners.

12. The combination of claim 6 wherein the helmet further comprises another mount point and the bracket and shield are mounted to the mount point.

13. The combination of claim 12 further comprises a pair of fasteners extending through the shield and the bracket to engage the mount points.

14. The combination of claim 13 wherein each of the fasteners is a threaded fastener and each of the mount points comprises a threaded opening receiving one of the threaded fasteners.

15. A method of connecting a camera mount bracket to a protective helmet having an identification shield mounted to the helmet, the method comprising the steps of:
removing the identification shield from the protective helmet;
placing the camera mount bracket against the helmet in a location normally occupied by the identification shield; and
remounting the identification shield to the helmet with the camera mount bracket sandwiched between the identification shield and the helmet.

16. The method of claim 15 wherein the step of removing the identification shield comprises the step of removing at least one fastener connecting the shield to the helmet; and the step of remounting the identification shield comprises the step of reconnecting the at least one fastener to the helmet.

17. The method of claim 15 wherein the step of removing the identification shield comprises the step of removing at least one threaded fastener connecting the shield to the helmet; and the step of remounting the identification shield comprises the step of reconnecting the at least one threaded fastener to the helmet.

18. The method of claim 17 wherein the step of reconnecting the at least one treaded fastener to the helmet comprises the step of inserting the at least one fastener through aligned openings in the identification shield and the camera mount bracket.

19. The method of claim 16 wherein the step of removing at least one fastener comprises removing two fasteners, and the step of reconnecting the at least one fastener comprises reconnecting the two fasteners to the helmet.

20. The method of claim 16 wherein the step of reconnecting the at least one fastener comprises the step of inserting the at least one fastener through aligned openings in the identification shield and the camera mount bracket.
